(19) United States
(12) Patent Application Publication
(10) Pub. No.: US 2006/0160056 A1
(43) Pub. Date: Jul. 20, 2006

(54) System for electronically administering a certification program

(76) Inventor: James Fogarty JR., Mystic, CT (US)

Correspondence Address: MCCORMICK, PAULDING & HUBER LLP, CITY PLACE II, 185 ASYLUM STREET, HARTFORD, CT, 06103, US

(21) Appl. No.: 11/225,849

(22) Filed: Sep. 13, 2005

Related U.S. Application Data
(60) Provisional application No. 60/609,441, filed on Sep. 13, 2004.

(51) Int. Cl. G09B 3/00

(52) U.S. Cl. 434/350; 434/362

(57) ABSTRACT

A system for electronically administering a certification program includes a server capable of being remotely accessed by workstations, a memory unit, and a programmable processor. The processor has training, maintenance and administration modules that use training, maintenance, and administrative content stored in the memory unit to perform various certification program-related functions. With the system, administrators are enabled to easily perform tasks like scheduling, updating and reviewing completion of training and maintenance, viewing test results and feedback, and responding to questions. Other users, like employees receiving training and performing maintenance, can use the system to have a training course administered or use the system to have interactive maintenance procedures provided. Problems during testing or maintenance can be alleviated by linking to appropriate training course subject matter.

### CROSS REFERENCE TO RELATED APPLICATIONS

The present applications claims priority from U.S. Provisional Application 60/609,441, filed Sep. 13, 2004.

### FIELD OF THE INVENTION

The present invention relates generally to the electronic administration of a formal or informal certification program, and particularly relates to the electronic administration of a certification program with training and maintenance requirements.

### BACKGROUND OF THE INVENTION

In today's complex, technological world, many industry groups, businesses, government agencies, and the like have increasingly encouraged or required programs for initial and on-going certification of personnel, procedures and equipment to ensure that various activities are safely, securely and reliably performed. Manufacturing and maintenance certification standards, like ISO 2000 and the U.S. military's Quality Assurance Program require intensive documentation not only of the training and certification of personnel, but also documentation of the proper completion of manufacturing and maintenance tasks. As regulations change in the face of real-world experience or administrative action, the new information must be incorporated into the training and old or inaccurate information purged. Procedures for use in manufacture and maintenance of products must also be updated to reflect the latest guidance. Maintenance schedules, which dictate the periodicity at which various required tasks must be accomplished (often referred to as a Preventive Maintenance Systems [PMS]), must be kept up-to-date and annotated upon completion of the tasks.

Regarding training for personnel, mere completion of the required training has typically not been seen as satisfactory. Before certification could be established or renewed, retention and understanding must also have been demonstrated through various types of testing. Inadequate performance on testing often requires remedial training and re-testing. For management or a regulatory agency to effectively oversee personnel certification, it has not been sufficient to only require and administer training and testing. Records had to be kept showing that training was completed, and these records generally indicated the date, attendance, and subject matter covered. The same record-keeping requirements also applied to the testing. For test records, it was desired and/ or required to keep more than just a record of scores indicating passage or failure. Questions that have been consistently answered incorrectly, even by test takers who ultimately pass, were a valuable source of information about potential deficiencies both in practice and in the training/testing programs. Given a large and/or geographically dispersed body of personnel, it was also necessary to reliably distribute and administer the training materials and to collect and analyze the recorded results. To ensure that the information recorded actually reflected the level of knowledge of certified personnel, various means had to be employed to keep test questions and answers confidential. In practice, this presented a serious administrative burden and expense for all involved.

Traditionally, training and testing were administered in person by either an internal or external training administrator. Instruction tended to be a standardized classroom format. The initial recording of results was manual, even if the information was later recorded in an electronic format. Personally administered training and testing had the distinct advantage of allowing real-time interaction with between the administratoror and training recipients. The lesson could be tailored to the needs or wants of the recipients. Additionally, if the administrator were aware of recent developments that had not yet been incorporated into a written curriculum, the administrator could personally present this information to the class. Of course, the limited number of administrators meant that either training had to be given less frequently or in fewer locations. Furthermore, the quality of training and integrity of the testing process tended to vary considerably from location to location.

Efforts have been made to streamline the training process by standardizing curriculum and recording lessons in various media formats (e.g. tapes, CDs, videotapes). Of course, while pre-recorded lessons were more easily accessible to the recipients, real-time interaction with administrators was impossible and instruction could not be tailored to the needs or desires of the training group. Additionally, the pre-recorded information quickly became out-dated. Keeping training material current necessitated the distribution of new material and required additional tracking to ensure that the most current materials were being employed. Testing still required an actual administrator or proctor, or else self-testing had to be permitted. The absence of an administrator made it difficult to verify that the training had actually been completed and that testing was accomplished under the appropriate conditions. Problem areas uncovered by testing could not be immediately identified and addressed. Further, record keeping was in no way simplified and tended to be less standardized and accurate as the burden was increasingly shifted to a variety of training recipients from a smaller number of administrators.

Utilizing computer-based media for training allowed for more interactive training that was readily accessible while still somewhat adaptable to the needs and desires of the training recipients. However, new computer-based media still had to be distributed to keep the information current and real-time interaction with administrators was not possible. While tests could also be stored on the computer-based media and taken on the computer, record keeping was still essentially a manual activity, and administrator oversight of training and testing was only after-the-fact. The format of information presented in computer-based interactive training still tended to be somewhat limited. Collection and recording of training data still presented the same burden.

Regarding the certification of manufacturing and maintenance, traditionally procedures were kept and employed in hard-copy form at each site where procedures would be required. Prior to maintenance, the appropriate procedure was selected. After completion a hard-copy schedule was annotated with completion. While procedures and schedules have been increasingly stored on CD-ROM and similar formats, the procedures and schedules are still printed and used as before. For simplicity, many work centers generated a folder of hard-copy procedures that could be eraseably marked rather than printing a new procedure each time it was required. Maintenance schedules were tracked manually. When changes to procedures or schedules were promulgated, various manual up-dates had to be accomplished and errors such as inadvertently using an out-dated procedure or failing to schedule and perform maintenance at the proper periodicity were common.

Accordingly, it will be appreciated that there is a need for a system and method of administering on-going certification training in which training content is standardized and easily distributed, while still allowing current information to be immediately incorporated and maximizing the interactivity and adaptability of the training. Further, it can be seen that there is a need for a system and method of administering training that alleviates the burden to both the training administrator and recipients of record-keeping and allows the recorded information to be quickly and easily analyzed. Additionally, it can be seen that there is a need for a readily updatable system that incorporates personnel training and record-keeping with equipment maintenance procedures and scheduling to enable the comprehensive maintenance of a certification program.

### SUMMARY OF THE INVENTION

Systems for sharing computerized information over networks, such as the world-wide web (the internet) and local area networks (LAN), have opened up a new array of possibilities for permitting wide distribution and flexible administration of certification training content, while still allowing interaction with and oversight by training providers. Accordingly, it is an object of the present invention to provide a system and a method for administering computer-based training in which training material can be maintained and up-dated at a centralized location.

It is a further object of the present invention to provide a system and a method for administering computer-based training in which on-going training is facilitated by tracking required training and generating notifications of up-coming required training.

It is a further object of the present invention to provide for a method and a system for the comprehensive administration of a certification program by allowing the administration of training and maintenance procedures and scheduling.

The foregoing objects are provided by a central server which can be accessed by properly authorized administrators either directly or remotely and into which the most up-to-date data is entered. Training, administrative, and task-oriented applications are executed on workstations allowing training, testing, and tasks to be scheduled, performed and recorded. The functioning of the system and method, and other advantages, will be clear in view of the detailed description of the preferred embodiment that follows.

### BRIEF DESCRIPTION OF THE DRAWINGS

FIG. 1 shows an overview of the system according to a preferred embodiment of the present invention, including a plurality of workstations that can be used in connection with the preferred embodiment of the present invention.

FIG. 2 shows a detailed view of the server according to the preferred embodiment of the present invention.

FIG. 3 shows a detailed view a workstation that can be used in connection with the preferred embodiment of the present invention.

FIGS. 4A-B show the structure and operation of a training module according to the preferred embodiment of the present invention.

FIG. 5 shows the structure and operation of a maintenance module according to the preferred embodiment of the present invention.

FIG. 6 shows the structure and operation of an administration module according to the preferred embodiment of the present invention.

FIG. 7 shows a detailed view of a training options sub-module of the administration module according to the preferred embodiment of the present invention.

FIG. 7A shows a detailed view of a notification sub-module of the administration module according to the preferred embodiment of the present invention.

FIG. 8 shows a detailed view of a maintenance options sub-module of the administration module according the preferred embodiment of the present invention.

### DETAILED DESCRIPTION OF THE PREFERRED EMBODIMENT

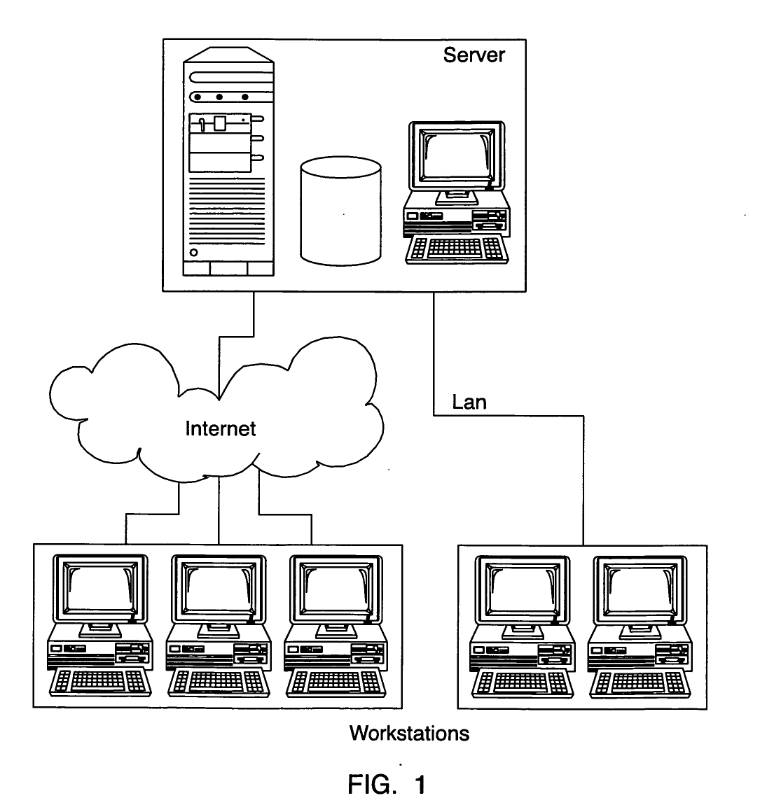

FIGS. 1-3 show an overview and detail views of the system (and workstations that can be connected to the system) according to the present invention. The preferred embodiment will be described in the general context of a company with an internal administrator and employees who are the users of the system. It will be dear to those skilled in the art that the present invention is not limited to this context, but is equally applicable to other situations. For instance, a company could use a third-party administrator, or a government or private certification agency could act as the administrator. Obviously, any personnel or equipment subject to certification requirements could be substituted for employees. Similarly, administrative and employee functions could be divided between different entities. For instance, a company that produced components under contract for an original equipment manufacturer (OEM) could administer an internal certification program, while allowing the OEM limited administrator access to verify certification requirement accomplishment. The term “user,” as used herein, is meant to refer to any user of the system and/or method, and is not intended to distinguish between an administrative user or an employee user.

Additionally, in relation to the present invention, the term “certification program” includes, but is not limited to formal certification programs such as ISO 2000. The term “certification program” also includes any program, however informal, with the goal of establishing training and/or task-based requirements and monitoring/assessing compliance with those requirements, and is not limited to any particular industry or activity.

A central server is provided that stores on a memory unit training content, maintenance content, and administrative content, which is provided to authorized users (e.g. administrators and employees). The server is optionally directly accessed, or preferably remotely accessed by workstations via well-known means such as the Internet or a LAN, or a combination of means depending upon the location of a given user. Compatible workstations can include laptop computers, desktop computers, PDAs, dedicated terminals, and the like. As will be described, for some modules it is preferred that the server be adapted to use a workstation to predominantly perform some functions locally, while the server sends updates and receives results. For other applications, the modules use sub-modules that are preferably substantially located on the server with the workstation using a standard browser, or the like, as a user interface. Details regarding the various components will be explained below.

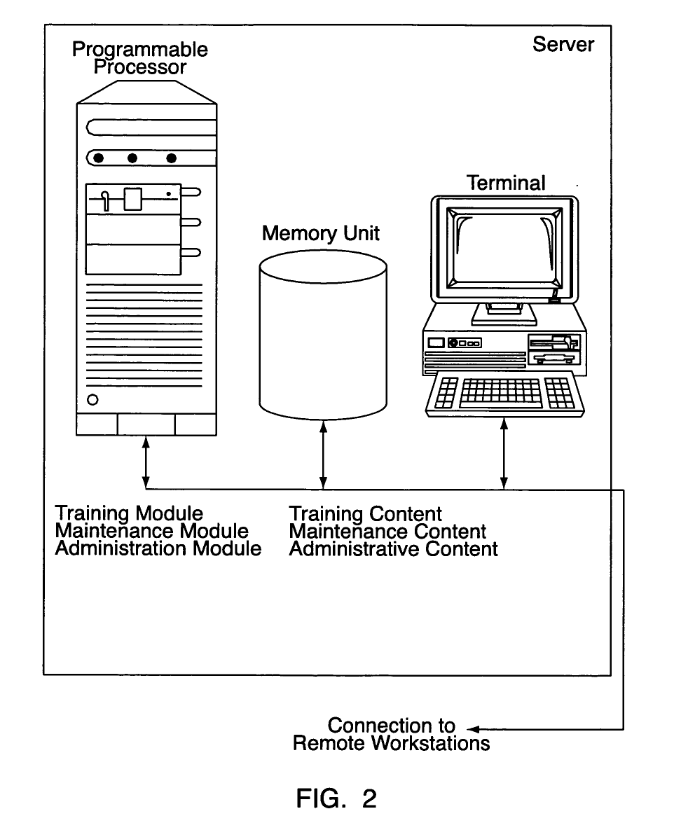

The server, shown in detail in FIG. 2, preferably includes a dedicated terminal allowing direct access to the server, a memory unit, and a processor. The memory unit is used to store and retrieve training, maintenance and administrative content, as will be explained in greater detail below. It is preferred to also provide an automatic memory back-up means (not shown) for greater redundancy and reliability in the even of event of a memory unit failure. The processor is programmable and preferably executes a training module, a maintenance module, and an administration module.

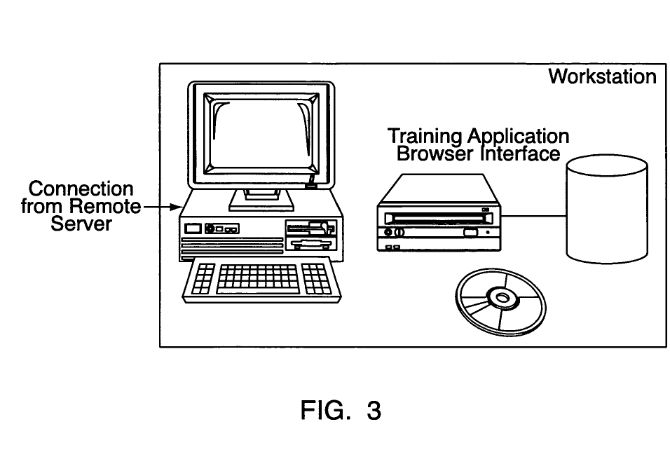

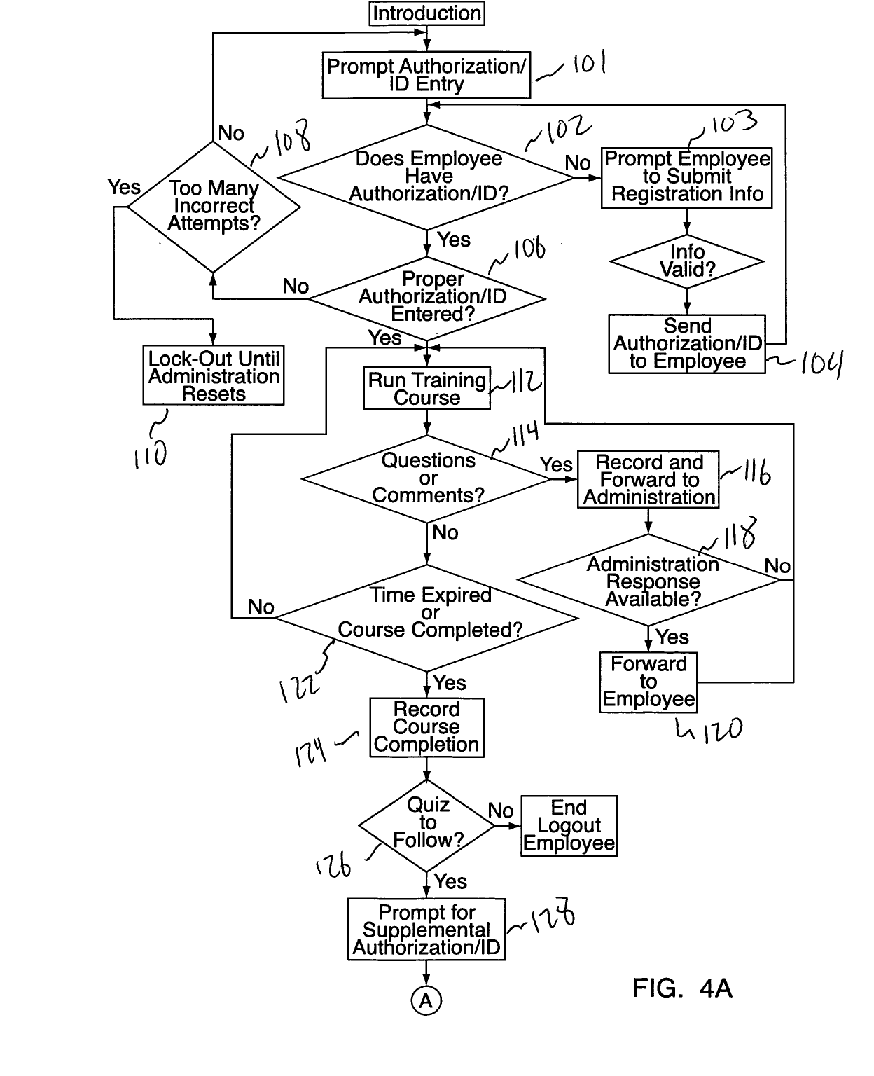

A workstation that can be used with the system, as shown in FIG. 3, preferably includes a user interface, a browser, and an external drive (such as a CD drive or DVD drive) for loading and executing an application, particularly a training application, from external memory media. The workstation also preferably includes internal memory (e.g a hard drive) so that various applications, particularly the training application, can be loaded to and executed from the internal memory.

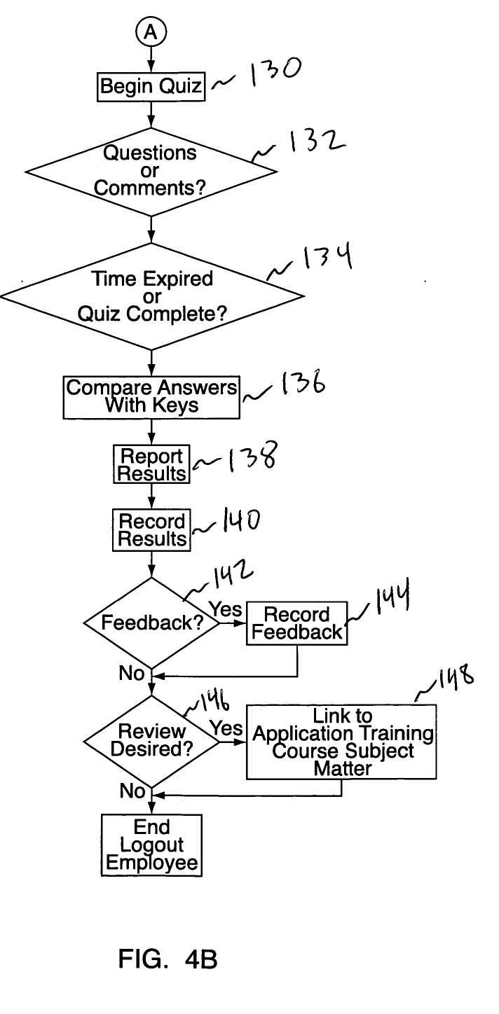

FIGS. 4A-B show a flowchart depicting the structure and operation of a training module according to an embodiment of the present invention. It will be understood by those skilled in the art that every action described need not occur during the same session. In the event the application software optionally employed by the server is not already loaded on the workstation to be used in connection with the training module, the employee installs the training application (not shown—preferably via a CD due to the size of the training application, though the training application could also be down-loaded from the server, for instance) or from the CD.

The training application preferably runs automatically from the workstation upon loading and prompts the employee for an authorization/ID (101). Running the application establishes communication (e.g. over the Internet or a LAN) with the training module on the server, allowing the training module to perform various training and administration functions such as verifying the authorization/ID from stored registration data (included in the administrative content on the memory unit. The authorization/ID is either previously established by the employee, given by an administrator, randomly selected, or established in some other related fashion. In the event the employee does not have, or has forgotten, the authorization/ID (102), the employee is preferably linked to an online registration process (103) whereby he or she can obtain a new code or receive a notification of his or her existing code (104). The new code or existing code notification is preferably communicated to the employee electronically (e.g. by email) so training is not excessively delayed. If the employee does not enter the proper code (106), he or she is preferably prompted to try again, although an administrator can optionally configure the server to lock the employee out from the training application after a pre-established number of incorrect attempts (108, 110). Administrator permission will need to be received by the server, in such an instance, for the training application to release the lock out. (The authorization/ID entry procedure is preferably similar for the maintenance and administrative modules, although additional information may be optionally solicited at in connection with use of those modules. Accordingly, it will be referred to but not again described in detail.)

Once a proper authorization/ID is entered, the appropriate training course is displayed 112 preferably using the training application. The bulk of the training course subject matter is preferably contained on the workstation (on external media or hard drive) for faster accessing, with the server providing up-dates based on an assessment of the edition contained on the workstation. Alternatively, all the training subject matter, or a given segment of training subject matter can be downloaded from the server with each use of the training application. The training subject matter preferably contains multiple formats including text, audio, and high-resolution video that, given the bandwidth typically available to most companies, could not download in a reasonable period of time.

Preferably, the employee can move through the training material or subject matter at his or her own pace, although a time limit (maximum and/or minimum) can also be established. Typically, the employee is allowed to review material more than once. Links to additional, non-required information (not shown), are optionally provided for viewing at the employee's discretion.

Questions can be provided before and during the training to test comprehension (e.g. the employee can be restricted from moving to a different subject in the training material until comprehension has been demonstrated by answering one or more questions), but the typical order is to include a quiz or test (quiz and test are used herein generically to refer to any number, type and format of questions for assessing retention/ comprehension) after the training material has been completed. Preferably, the employee is prompted to submit questions or problems with the training material during the training (114) (e.g. via instant messaging or email). The server records and then routes the employee's submissions to an administrator (116) optionally allowing for a real-time or near real-time response (118, 120), if an administrator is on-line during the training, without having an administrator physically present during the training. In the event there is a problem with the training subject matter, the administrator is able to update the information immediately, with the updates optionally communicated to all employees currently or subsequently involved in the training. When the employee completes the course or runs out of time, the training course ends (122, 124).

Upon completion of the training, the employee is typically prompted to take a quiz (126), or alternatively, the quiz may begin automatically upon completion of the training. There is obviously neither a requirement that a quiz follow every training course, nor that the quiz be taken immediately after completion of training course. The employee may be given time for study and review and allotted a future time in which he or she must take the quiz. Preferably, the quizzes are accessed from the training content of the server memory unit by the training module and taken on-line for enhanced security and updatability for questions and answers. Prior to taking the quiz the employee may optionally be required to re-enter supplemental authorization/ID (128). Preferably, the routine for entering the authorization/ID is similar to that described above in connection with initiating training.

Once the identifying information has been correctly entered, the quiz begins (130). The quiz may include content in various display formats, similar to the training course. The quiz may be timed or un-timed and may include various types of questions although multiple choice and short-answer questions are preferred as being readily computer graded (though computer graded questions are not required). As during the training, the employee is preferably allowed to submit questions or comments during the testing (132). When the employee completes the quiz, or when the allotted time is expended (134) (whichever comes first), the answers are compared with an answer key stored in the training content of the memory unit (136) and quiz results are typically displayed (138) (in the event that questions must be manually graded, results are optionally displayed or sent after manual grading has been completed). Alternatively, the quiz results may be communicated to the employee separately (e.g. via email) at some later time (e.g. after review by an administrator) or kept in confidence. The employee is preferably given the opportunity to review questions that were answered incorrectly and select links to the training subject matter related to correct answers (146, 148). Optionally, the employee enters feedback regarding the quiz and the training course (142, 144). The quiz results and any feedback are stored as training content on the server memory unit (140) for later access, as will be explained below.

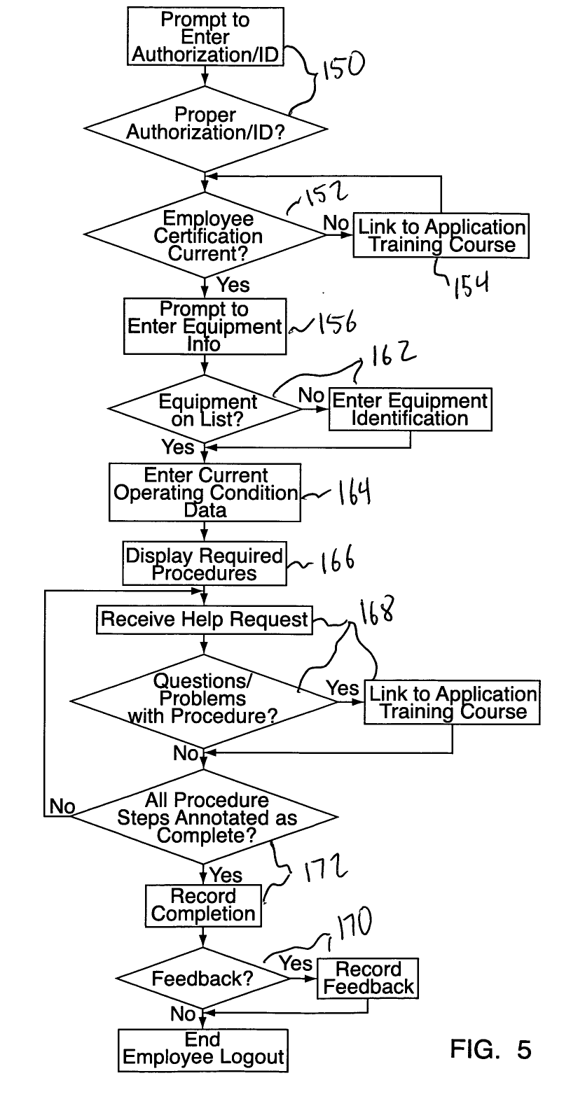

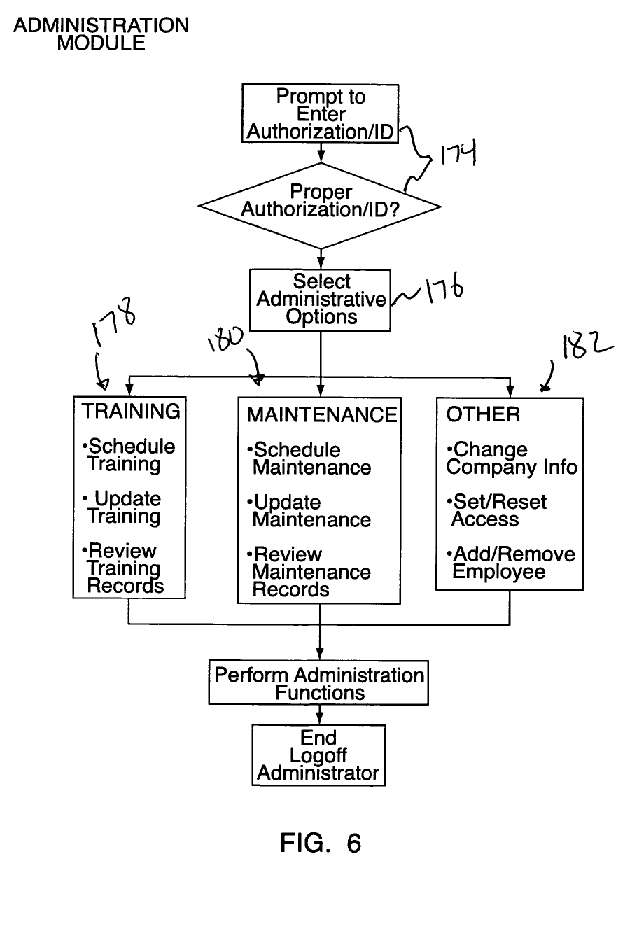

Turning to FIG. 5, a flowchart shows the structure and function of the maintenance module. At the worksite the employee accesses the maintenance application (preferably resident on the server) via a browser, or the like. Access is controlled (150) as described in connection with the training module, above. Using the entered authorization/ID, the maintenance module assesses whether the employee is properly certified (152). If not, the employee is optionally directed to the training module for any required training courses (154). Once a properly certified employee has been identified, the employee is also prompted to provide identifying information about the equipment to be serviced (160). If the equipment is not already stored on an equipment list on the server (in the maintenance content of the memory unit), the employee supplies the necessary information for inclusion on the equipment list (162).

Once the equipment has been properly identified, the employee enters information about current operating conditions (164) (e.g. equipment run hours). Based on the current operating conditions and preventive maintenance scheduling information (located in the memory unit maintenance content), the maintenance module selects and displays the most recent procedures (including checklists) for the required maintenance (166). If the workstation being used has printing capability, the employee may print a copy, if desired. Preferably, the procedures are interactive so that the employee may refer to the procedure and annotate any checklist on the workstation as corresponding steps are completed.

If the employee has difficulty regarding any part of the required preventive maintenance, a help sub-module (168) can link the employ back to the appropriate training course subject matter. Any problems/feedback concerning the procedure are optionally submitted and stored as maintenance content in the memory unit (170). An administrator can access this information and up-date the procedure and respond to the employee, as necessary (similar to the routine described above in connection with employee questions/problems during a training course. Once the maintenance has been successfully completed, the completion is recorded as maintenance content (172). Thus, the scheduling and tracking of required and completed preventive maintenance is reliably accomplished, while minimizing the opportunity for errors involving uncertified personnel, and incorrect scheduling and procedures.

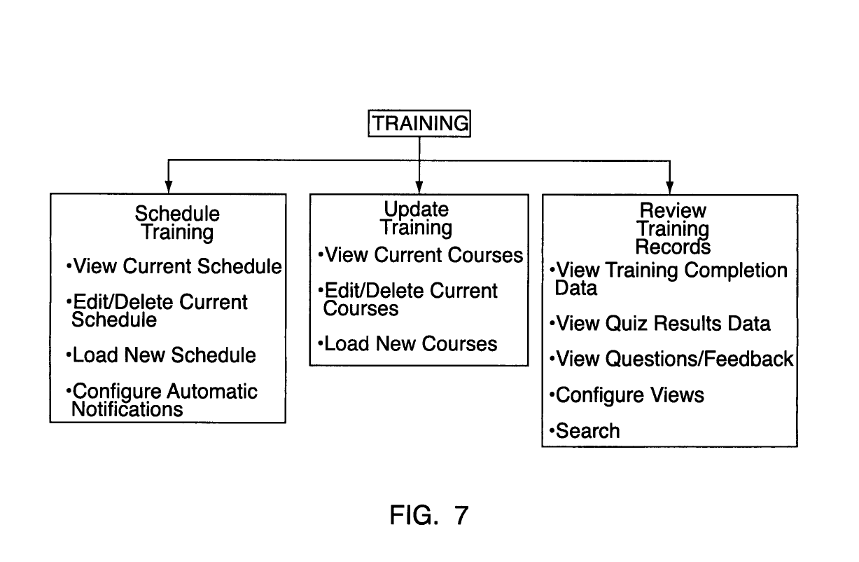

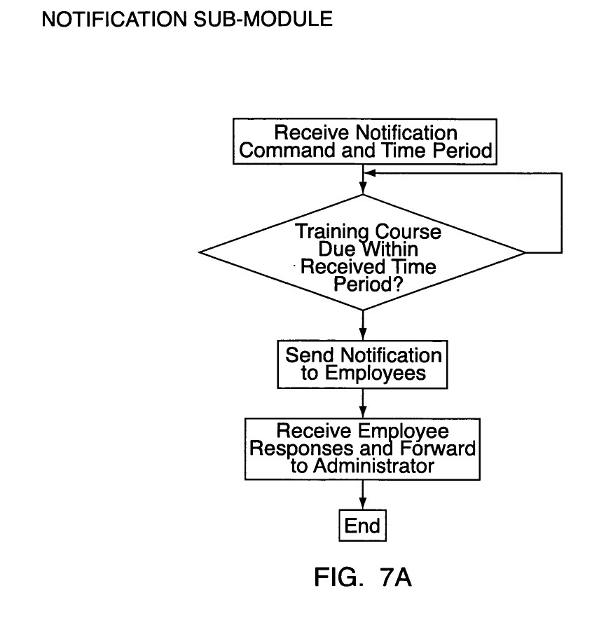

The structure and function of the administration module is shown in FIG. Z. An administrator accesses the server by providing proper authorization/ID (174) (as described above in connection with the training module). Once proper authorization/ID has been provided, the administration module provides the administrator with a choice of administrative functions (176). First, the TRAINING options (178) (seen in detail in FIG. 7) will be described. SCHEDULE TRAINING allows the administrator to generate or load schedules of required training and configure training notification options. When the administrator configures training notification options (using the notification sub-module as seen in FIG. 7A), the administration module automatically notifies designated employees when training courses become required to maintain certification. By selecting UPDATE TRAINING, the administrator is permitted to add new training subject matter, and remove or edit existing training subject matter from the training content.

The REVIEW TRAINING RECORDS function enables the administrator to check on the status of training completion and review any quiz results and employee feedback that has been provided. When reviewing quiz results, the administrator is preferably prompted to select one of a variety of report formats which allow for viewing of individual results, group results, and historical results. The selectable formats also allow results to be sorted by fields such as employee name/ID, training course, and date. Results summaries displaying results in tabular and/or chart form can also be selected. Results can also be searched for particular data. It can be seen from the foregoing that a powerful tool is provided which allows an administrator to administer training and quizzes to a range of geographically dispersed training recipients (typically employees), the results of which are automatically stored and accessible by the administrator in a variety of informative formats.

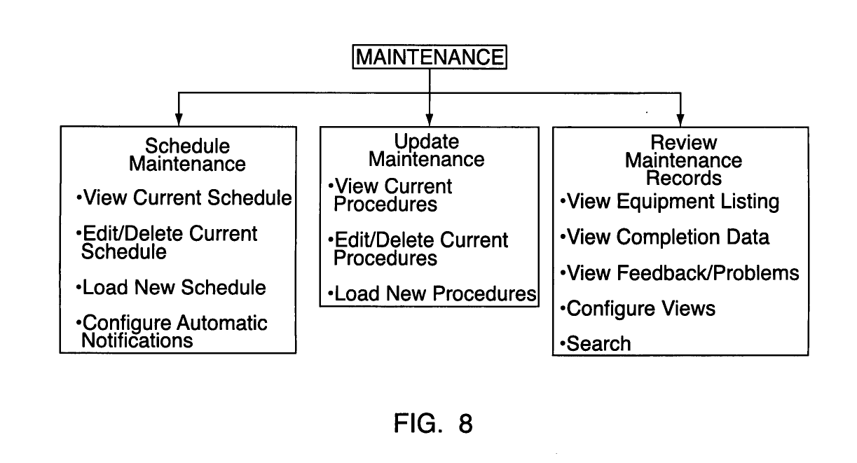

Turning to the MAINTENANCE options (180) (seen in detail in FIG. 8), when the administrator selects SCHEDULE MAINTENANCE he or she is enabled to view and update maintenance schedules and configure notifications (similar to FIG. 7A) to applicable employees for automatic notification as maintenance requirements become due according to the schedule. UPDATE MAINTENANCE allows the administrator to add new procedures, and edit or remove out-dated procedures. REVIEW MAINTENANCE RECORDS enables the administrator to review all equipment that has been entered in the system and view current operating conditions data and maintenance completion information. As with the training records, the administration module preferably allows the administrator to search the maintenance records and also select between a variety of formats to aid in locating or displaying the desired information. The administrator is also allowed to access and view employee feedback regarding problems and questions concerning the maintenance procedures.

Under the OTHER option (182), the administrator is provided with a variety of administrative tools that allow the administrator to configure access to server (e.g. set/reset passwords, change authorized employee lists, change company information).

Thus the present invention allows for improved accomplishment and tracking of equipment certification requirements, while greatly reducing the administrative burden. It will be appreciated that the present invention is not limited to the embodiment described, but also encompasses variations and equivalents known to those skilled in the art.

I claim:

1. A system for electronically administering a certification program, the system comprising:
a server remotely accessible from a workstation, the server including a memory unit and a processor;
the memory unit storing certification program-related training content, the training content including a training schedule;
the processor being programmable and having a training module for administering a certification program-related training course to an authorized user and an administration module for enabling a plurality of administrative functions for an authorized user; and
the administration module having a configurable notification sub-module for generating and distributing a notification of an upcoming training course to a user based on the training schedule;
whereby a workstation remotely connected to the server and having a user interface can allow an authorized user to utilize the training module and the administration module.

2. The system of claim 1, wherein the training content stored in the memory unit further includes a test having a plurality of test questions and a test answer key;
the training module of the programmable processor is also for administering the test to an authorized user;
the training module also has a test-results sub-module for identifying an incorrect answer submitted by an authorized user to one of the test questions based on the test answer key; and
the training module also has a test review sub-module for linking an authorized user to subject matter of the training course related to the test question answered incorrectly.

3. The system of claim 1, wherein the memory unit also stores certification program-related maintenance content, the maintenance content including an interactive maintenance procedure;
the programmable processor also has a maintenance module for providing the interactive maintenance procedure to an authorized user; and
the maintenance module has a help sub-module for receiving a help request from an authorized user regarding the interactive maintenance procedure and linking an authorized user to subject matter of the training course related to the help request;
whereby a workstation remotely connected to the server and having a user interface can also allow an authorized user to utilize the maintenance module.

4. The system of claim 1, wherein the memory unit also stores certification program-related maintenance content and certification program-related administrative content, the maintenance content including an interactive maintenance procedure and the administrative content including a certified personnel list;
the programmable processor also has a maintenance module for providing the interactive maintenance procedure to an authorized user; and
the maintenance module has a certification verification sub-module for verifying that an authorized user is on the certified personnel list before providing an interactive maintenance procedure to an authorized user;
whereby a workstation remotely connected to the server and having a user interface can also allow an authorized user to utilize the maintenance module.

5. The system of claim 4, wherein the certification verification sub-module of the maintenance module also links an authorized user to subject matter of the training course requiring completion for inclusion on the certified personnel list upon determining that an authorized user is not on the certified personnel list.

6. The system of claim 1, wherein the training module for administering the training course is adapted to administer a training course run on a workstation by an authorized user.

7. The system of claim 3, wherein the administration module of the programmable processor also allows an authorized user to update the training content and the maintenance content stored on the memory unit.

8. The system of claim 2, wherein the training content stored in the memory unit further includes training completion data and test results data;
the administration module of the programmable processor also has a review training records sub-module for allowing an authorized user to configurably view the training completion data and the test results data.

9. A system for electronically administering a certification program, the system comprising:
a server remotely accessible from a workstation, the server including a memory unit and a processor;
the memory unit storing certification program-related training content, the training content including a test having a plurality of test questions and a test answer key;
the processor being programmable and having a training module for administering a certification program-related training course to an authorized user and for administering the test to an authorized user;
the training module having a test results sub-module for identifying an incorrect answer submitted by an authorized user to one of the test questions based on the test answer key; and
the training module also having a test review sub-module for linking an authorized user to subject matter of the training course related to the test question answered incorrectly;
whereby a workstation remotely connected to the server and having a user interface can allow an authorized user to utilize the training module.

10. The system of claim 9, wherein the memory unit also stores certification program-related maintenance content, the maintenance content including an interactive maintenance procedure;
the programmable processor also has a maintenance module for providing the interactive maintenance procedure to an authorized user; and
the maintenance module has a help sub-module for receiving a help request from an authorized user regarding the interactive maintenance procedure and linking an authorized user to subject matter of the training course related to the help request;
whereby a workstation remotely connected to the server and having a user interface can also allow an authorized user to utilize the maintenance module.

11. The system of claim 9, wherein the memory unit also stores certification program-related maintenance content and certification program-related administrative content, the maintenance content including an interactive maintenance procedure and the administrative content including a certified personnel list;
the programmable processor also has a maintenance module for supplying an authorized user with the interactive maintenance procedure; and
the maintenance module has a certification verification sub-module for verifying that an authorized user is on the certified personnel list before providing the interactive maintenance procedure to an authorized user;
whereby a workstation remotely connected to the server and having a user interface can also allow an authorized user to utilize the maintenance module.

12. A system for electronically administering a certification program, the system comprising:
a server remotely accessible from a workstation, the server including a memory unit and a processor;
the memory unit storing certification program-related training content and certification program-related maintenance content, the maintenance content including an interactive maintenance procedure;
the processor being programmable and having a training module for administering a certification program-related training course to an authorized user and a maintenance module for providing the interactive maintenance procedure to an authorized user; and
the maintenance module having a help sub-module for receiving a help request from an authorized user regarding the interactive maintenance procedure and linking an authorized user to subject matter of the training course related to the help request;
whereby a workstation remotely connected to the server and having a user interface can allow an authorized user to utilize the training module and the maintenance module.

13. The system of claim 12, wherein the memory unit also stores certification program-related administrative content, the administrative content including a certified personnel list; and
the maintenance module of the programmable processor also has a certification verification sub-module for verifying that an authorized individual is on the certified personnel list before providing the interactive maintenance procedure to an authorized user.

14. A system for electronically administering a certification program, the system comprising:
a server remotely accessible from a workstation, the server including a memory unit and a processor;
the memory unit storing certification program-related maintenance content and certification program-related administrative content, the maintenance content including an interactive maintenance procedure and the administrative content including a certified personnel list;
the processor being programmable and having a maintenance module for providing the interactive maintenance procedure to an authorized user; and
the maintenance module having a certification verification sub-module for verifying that an authorized user is on the certified personnel list before providing the interactive maintenance procedure to an authorized user;
whereby a workstation remotely connected to the server and having a user interface can allow an authorized user to utilize the maintenance module.
